(19) United States
(12) Patent Application Publication
(10) Pub. No.: US 2026/0154097 A1
(43) Pub. Date: Jun. 4, 2026

(54) ARTIFICIAL INTELLIGENCE POWERED DASHBOARD GUIDE

(71) Applicant: SAP SE, Walldorf (DE)

(72) Inventors: Erda Sheshi, Heidelberg (DE); Josha van Houdt, Neckargemünd (DE); Sumi Yun, Seoul (KR); Moritz Semler, Spechbach (DE); Michael Becker, Landau (DE)

(73) Assignee: SAP SE, Walldorf (DE)

(21) Appl. No.: 18/968,827

(22) Filed: Dec. 4, 2024

(51) Int. Cl. G06Q 10/0631; G06F 9/451; G06F 16/334

(52) U.S. Cl. CPC G06F 9/453; G06F 16/3347

(57) ABSTRACT

A computer-implemented method includes receiving, from a user interface, a query entered by a user inquiring usage of a set of dashboards associated with a process, obtaining one or more text segments that are semantically related to the query, composing a prompt using a prompt template which includes at least one placeholder for receiving the one or more text segments, prompting a generative artificial intelligence model using the prompt to generate a guide instructing usage of at least one dashboard in response to the query, and presenting the guide on the user interface. Related systems and software for implementing the method are also disclosed.

### BACKGROUND

Enterprise Resource Planning (ERP) systems are comprehensive software solutions that manage and integrate a company's financials, supply chain, operations, reporting, manufacturing, and human resource activities. Within this framework, dashboards are valuable tools that display data insights across these various areas, helping users monitor key performance indicators, identify trends, and make data-driven decisions. However, navigating these dashboards can be challenging, as users often struggle to select the most relevant dashboard, locate specific charts, and interpret complex visual data. These challenges are compounded by the use of diverse analytical tools, which may present information with differing design patterns and layouts, further complicating user interactions. Thus, room for improvements exists for enhancing user experience and navigation within ERP systems.

### BRIEF DESCRIPTION OF THE DRAWINGS

FIG. 1 is an overall block diagram of an example EPR system including an intelligent dashboard assistant.

FIG. 2 is a flowchart illustrating an example overall method for generating dashboard guides using artificial intelligence.

FIG. 3 is an architecture diagram of an example large language model.

FIG. 4 depicts a partial layout of an example dashboard for microdelivery overview.

FIG. 5 depicts a snippet of an example dashboard document on microdelivery process.

FIG. 6 depicts a snippet of an example process document on microdelivery process.

FIG. 7 depicts an example use case of generating a dashboard guide in response to a user query.

FIG. 8 is a block diagram of an example computing system in which described embodiments can be implemented.

FIG. 9 is a block diagram of an example cloud computing environment that can be used in conjunction with the technologies described herein.

### DETAILED DESCRIPTION

### Overview of Dashboards in ERP Systems

ERP is an integrated software solution that allows an organization to use a system of integrated applications to manage their business and automate many back-office functions related to technology, services and human resources.

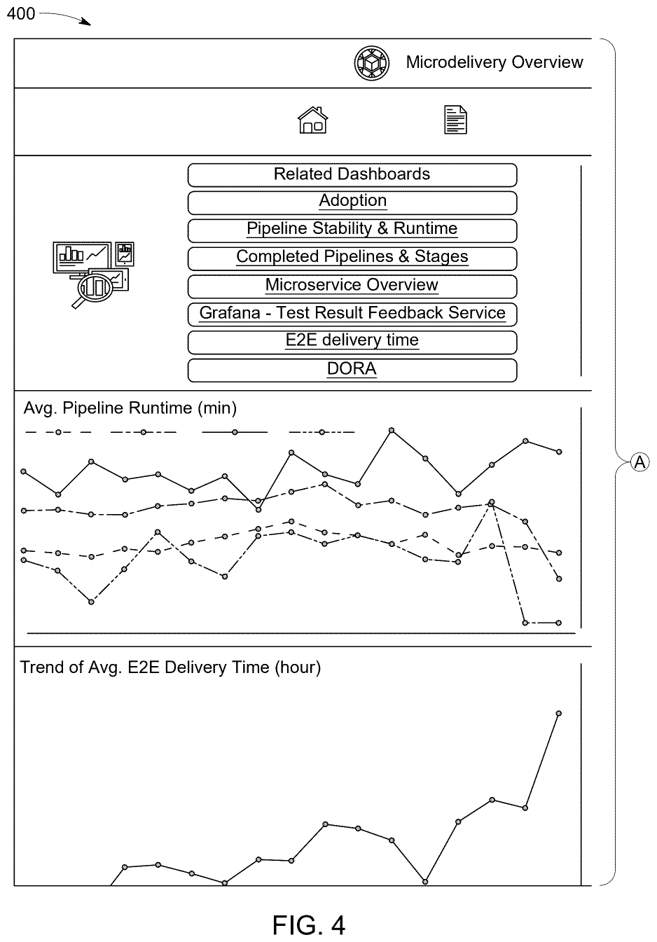

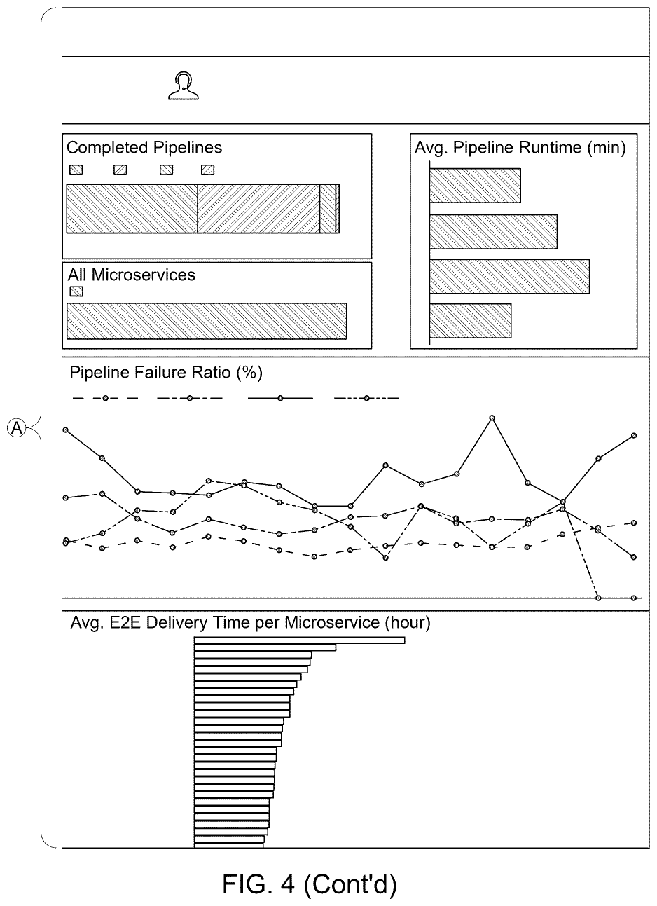

In ERP systems, dashboards play an important role in providing business insights across various functional areas, helping users monitor, analyze, and make decisions based on complex data. Each dashboard is designed to capture information about key performance indicators, trends, and operational metrics for distinct areas such as supply chain management, financial health, and workforce metrics. An example dashboard is shown in FIG. 4 and describe below. However, the sheer number of available dashboards and the vast amount of data presented across them can be overwhelming, especially for users who may not have detailed knowledge of dashboards or expertise in interpreting dashboard data.

Another technical challenge arises when dashboards present data related to multi-stage processes within an ERP environment. One example process is continuous integration and continuous delivery (CI/CD) microdelivery process, which automates the deployment and release of microservices, streamlining software updates and enhancements. The CI/CD microdelivery process can have four different process pipelines that are arranged in sequence: (1) microservice development (where new code is created); (2) release (where code is integrated and tested for quality); (3) validation (which ensures functionality and compliance with requirements); and (4) deployment (where the microservice is delivered to the production environment). Each pipeline in the process may rely on different data points, visualizations, and terminology, and understanding these dependencies is important for making informed decisions. However, users unfamiliar with the intricacies of these processes often lack the context necessary to comprehend the interdependencies displayed in the dashboards. This knowledge gap may lead to misinterpretation of metrics or overlooking key indicators that impact overall performance.

The diversity of tools and visual design patterns used across ERP dashboards adds further complexity, as each dashboard may have unique layouts, filters, and chart configurations depending on the analytical tool employed. Such design fragmentation can complicate the user experience, particularly for users who may not be trained to recognize these patterns or who lack experience in navigating such a wide array of dashboard interfaces. The absence of a standardized visual language can result in inconsistencies in data representation, making it challenging for users to interpret and compare insights across different dashboards accurately.

Another layer of complexity involves the lack of customization in many ERP dashboards. While dashboards can serve a wide range of user roles—such as managers, operations staff, and analysts—these users often have distinct data needs and analysis requirements. For instance, an operations manager may prioritize efficiency metrics, while a finance officer may focus on cost-related data. Non-customized dashboards may present excessive or irrelevant information, requiring users to manually filter and adjust settings to locate the insights they need. This can result in a time-consuming and inefficient navigation process, which may discourage regular use or lead users to overlook critical information. Additionally, without guidance tailored to their specific roles, users may apply incorrect filters or miss key visualizations relevant to their tasks, further reducing dashboard usability.

The technologies described herein address many of the above challenges by implementing an intelligent dashboard guide system that leverages generative artificial intelligence (AI), which can provide users with tailored navigation paths, context-aware recommendations, and real-time assistance for interpreting complex data visualizations.

### Example Overall Computing System Supporting Intelligent Dashboard Guide

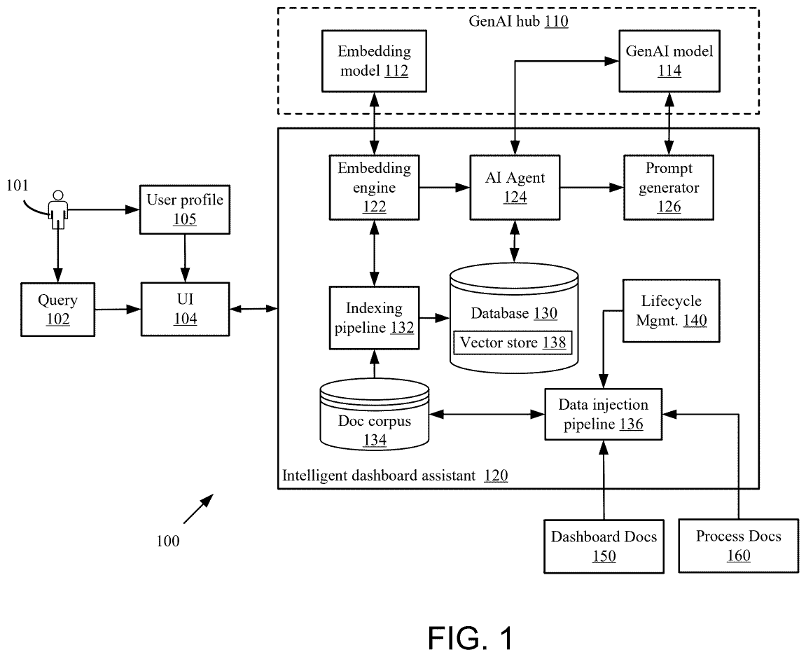

FIG. 1 shows an overall block diagram of an example ERP system 100 supporting intelligent dashboard guide, which includes an intelligent dashboard assistant 120 in communication with a generative AI hub 110.

The generative AI hub 110 can be used to provide generative AI (“GenAI”) capabilities to the intelligent dashboard assistant 120. In some examples, the generative AI hub 110 can be hosted externally (e.g., on a third-party platform). In other examples, the generative AI hub 110 can be deployed locally on the ERP system 100. The generative AI hub 110 can include an embedding model 112 and a generative AI model 114. The embedding model 112 can be configured to transform input text into a dense vector representation that captures semantic meaning of the input text. In some examples, the embedding model 112 can be text-embedding-ada-002 provided by OpenAI. In other examples, the embedding model 112 can be others, such as Bidirectional Encoder Representations from Transformers (BERT), FastText, Word2Vec, GloVe, or the like. The generative AI model 114 is configured to generate natural language text or responses based on input prompts. Example generative AI model 114 can be Generative Pre-trained Transformer (GPT) or BERT-based models, or the like. Although in the depicted examples the embedding model 112 and the generative AI model 114 are shown as two different units, in other examples, the embedding model can be a component of the generative AI model.

The intelligent dashboard assistant 120 can be configured to create and maintain a database 130 during a design phase. The database 130 can include a vector store 138 (also referred to as a “vector database”), which stores vector embeddings, as described further below. During a runtime phase, an end user 101 can enter a query 102 through a user interface 104 (UI). The query 102 can be expressed in natural language and contain inquiries about usage of a set of dashboards related to a process that is supported by the ERP system 100. In response to the query 102, the intelligent dashboard assistant 120 can be configured to provide a detailed user guide, offering step-by-step instructions for navigating the relevant dashboards, interpreting visualizations, and applying filters to access specific data insights. In some examples, a user profile 105 associated with the user 101 can be automatically retrieved (along with the query 102) and stored in the database 130. The intelligent dashboard assistant 120 can be configured to generate the user guide customized for the user 101 based on the user profile 105.

The intelligent dashboard assistant 120 can include an embedding engine 122, an AI agent 124, and a prompt generator 126. The embedding engine 122 can utilize the embedding model 112 to map words, sentences, or a text segment to a multi-dimensional vector of real numbers. Consequently, the embedding engine 122 can convert the user query 102 into a vector embedding (also referred to as “input vector embedding), which captures semantic and syntactic relationships among the words or tokens in the user query 102.

The AI agent 124 can be multi-functional. For example, the AI agent 124 can call different functions to measure similarity between vector embeddings, retrieve user profile, extract dashboard information or domain knowledge, etc. In some examples, the AI agent 124 can be implemented using the ReAct framework, as described more fully below.

In certain aspects, the AI agent 124 can be configured to search the vector store 138, which stores a plurality of vector embeddings corresponding to respective text segments. The searching can identify, among the plurality of vector embeddings, one or more target vector embeddings that match the input vector embedding. Specifically, the AI agent 124 can be configured to measure similarities between the input vector embedding and the plurality of vector embeddings stored in the vector store 138. An example similarity measurement can be cosine similarity, which quantifies the cosine of the angle between two vectors. A high cosine similarity indicates a smaller angle and hence a higher degree of semantic similarity between text represented by the two vectors. The AI agent 124 can be configured to rank the vector embeddings stored in the vector store 138 based on their cosine similarity scores relative to the input vector embedding. The one or more target vector embeddings can be identified as those with the highest cosine similarity scores (e.g., top N, where N is a predefined integer), indicating they represent the closest match in terms of semantic content.

The prompt generator 126 can be configured to automatically generate a prompt based on a prompt template and submit this prompt to the generative AI model 114. In response, the generative AI model 114 can generate a reply, which can be formatted by the intelligent dashboard assistant 120 and presented as a user guide on the user interface 104.

The prompt template can include specific instructions for the generative AI model 114 to generate context-aware guidance of navigating relevant dashboards based on the user query 102. The prompt template can include one or more placeholders which can be populated with relevant text. For example, one placeholder can be filled with the received user query 102. Another placeholder can be populated with text segments including descriptions of relevant dashboards. An additional placeholder can be replaced with text segments describing the relevant process. Yet a further placeholder can be populated with the user profile 105. These text segments correspond to the identified target vector embeddings, which can be retrieved from the database 130 by the AI agent 124.

Including the relevant text segments, user profile, and the user query in the prompt provides the generative AI model 114 with contextual information that enhance its understanding of the user's needs as well as pertinent knowledge within the relevant domain of expertise, thereby improving the accuracy and relevance of the generated response. In other words, by incorporating such contextual information, the generative AI model 114 can tailor its reply to the specific context of the user query, leading to more meaningful and actionable recommendations.

In some examples, one or more target documents can be identified. These target documents contain relevant text segments associated with the target vector embeddings (e.g., the ones with the highest similarity score determined by the similarity analyzer 124). In some examples, a target document can include multiple relevant text segments. In some examples, a target document can be a dashboard document, which includes in-depth descriptions of a specific dashboard, such as its purpose, available filters, and explanations of each data object (e.g., charts, graphs, tables) supported by the dashboard. In some examples, a target document can be a process document, containing detailed descriptions of a process related to the relevant dashboards. The relevant text segments can be stored in the database 130.

The target documents can be maintained in a document corpus 134, which represents a central repository of documents related to the dashboards and processes supported by the ERP system 100. To create the document corpus 134, a data injection pipeline 136 can be used to retrieve relevant documents from a variety of data sources, such as a data source containing dashboard documents 150, and another data source containing process documents 160. Example process for document retrieval is described further below.

As noted above, the database 130 can be created in the design phase and maintained by the intelligent dashboard assistant 120. For example, the intelligent dashboard assistant 120 can include an indexing pipeline 132 which is configured to generate the plurality of vector embeddings stored in the vector store 138 based on documents contained in the document corpus 134.

In some examples, the indexing pipeline 132 can divide each document into smaller text segments, which can be defined by a predetermined length of text (e.g., number of tokens). In some examples, a predefined overlap between adjacent text segments can be introduced to ensure continuity of context across text segments. This segmentation approach can be applied uniformly across different document types, such as spreadsheets, PDFs, Word documents, XML files, or the like. Each document type can be parsed according to its structure. For example, spreadsheets can be segmented by rows or cell ranges, PDFs and Word documents by paragraphs or sections, and XML files by specific nodes or tags, etc. The segmentation process ensures that even complex or lengthy documents are broken down into manageable segments, facilitating vector embedding and retrieval.

After the documents are segmented, each text segment can be processed by the embedding engine 122 (e.g., utilizing the embedding model 112) to generate a vector embedding which captures the semantic meaning of the text segment. The generated vector embeddings can be stored in the vector store 138. In addition to the vector embeddings, the corresponding text segments and relevant metadata can also be indexed alongside the embeddings in the database 130. During runtime, the AI agent 124 can search the database 130 for efficient data matching and retrieval, enabling the intelligent dashboard assistant 120 to quickly identify and utilize relevant text segments (e.g., based on vector similarity) for composing a context-aware prompt for sending to the generative AI model 114.

In some examples, the intelligent dashboard assistant 120 can further include a lifecycle management unit 140 which is configured to ensure that the database 130 is kept up to date with the most current information. An administrator can configure the lifecycle management unit 140 to monitor changes in the dashboard documents 150 and process documents 160, ensuring that updates to these documents can be timely reflected in the document corpus 134, which in turn affects the content of the database 130. Additional details of the lifecycle management unit 140 and its operations are described further below.

In practice, the systems shown herein, such as the ERP system 100, can vary in complexity, with additional functionality, more complex components, and the like. For example, there can be additional functionality within the intelligent dashboard assistant 120. Additional components can be included to implement security, redundancy, load balancing, report design, data logging, and the like.

The described computing systems can be networked via wired or wireless network connections, including the Internet. Alternatively, systems can be connected through an intranet connection (e.g., in a corporate environment, government environment, or the like).

The ERP system 100 and any of the other systems described herein can be implemented in conjunction with any of the hardware components described herein, such as the computing systems described below (e.g., processing units, memory, and the like). In any of the examples herein, user queries, dashboards, dashboard/process documents, vector embeddings, prompts, text segments, and the like can be stored in one or more computer-readable storage media or computer-readable storage devices. The technologies described herein can be generic to the specifics of operating systems or hardware and can be applied in any variety of environments to take advantage of the described features.

### Example Lifecycle Management

In some examples, the lifecycle management unit 140 can be configured by the administrator to periodically check the dashboard documents 150 and process documents 160 for any changes. For example, the lifecycle management unit 140 can be set to perform these checks every day or at another regular interval. During these checks, the lifecycle management unit 140 evaluates whether there have been any additions, deletions, or modifications to the dashboard documents 150 and process documents 160. If changes are detected, the lifecycle management unit 140 then controls the data injection pipeline 136 to retrieve the updated dashboard/process documents and update the document corpus 134 accordingly.

Alternatively, the lifecycle management unit 140 can be configured to operate the data injection pipeline 136 on demand, triggering document retrieval only when changes occur in the dashboard documents 150 and process documents 160. In this configuration, addition of a new dashboard/process document, deletion of an existing dashboard/process document, or modification to a newer version of an existing dashboard/process document can automatically trigger the lifecycle management unit 140 to activate the data injection pipeline 136 for document retrieval. In still some examples, the administrator can manually trigger document retrieval.

Any update to the document corpus 134 can cause corresponding update of the database 130. For example, if a new document is added to the document corpus 134, the indexing pipeline 132 can divide it into text segments, each of which can be converted into a corresponding vector embedding which is then saved in the vector store 138, along with the corresponding text segment stored in the database 130. Similarly, when an outdated document is deleted from the document corpus 134, the associated text segments and their corresponding vector embeddings can be removed from the database 130 (and the vector store 138). In cases where an existing document in the document corpus 134 is modified or replaced with a new version, the document can be re-segmented, and each updated text segment can be re-converted into new vector embeddings, which will replace the old vector embeddings in the data store 138, and the corresponding text segments stored in the database 130 can be refreshed as well.

Thus, the lifecycle management unit 140 ensures that the database 130 consistently reflect the most current and accurate dashboard/process information. This ongoing maintenance enables the intelligent dashboard assistant 120 to reliably retrieve and utilize relevant data, thereby enhancing its effectiveness in generating recommendations in response to the user queries.

### Example Overall Method for Generating Dashboard Guide

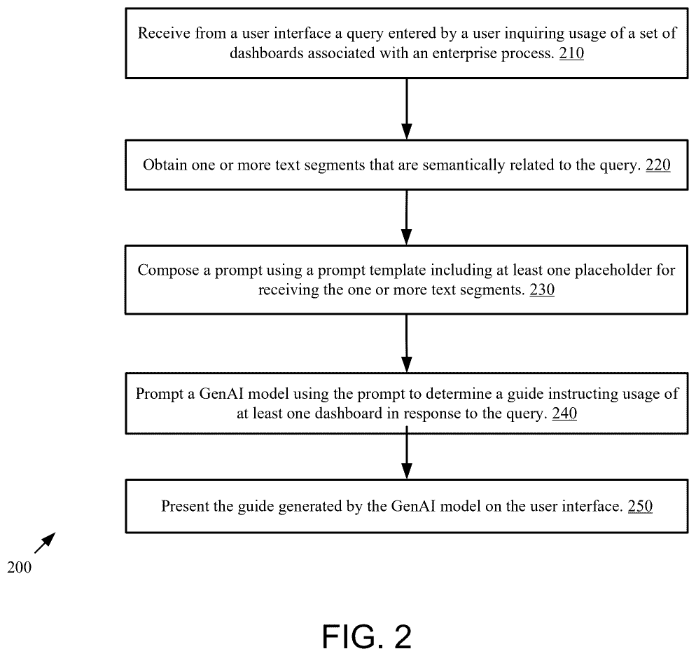

FIG. 2 is a flowchart illustrating an example overall method 200 for generating intelligent dashboard guides in ERP systems. The method 200 can be performed, e.g., by the intelligent dashboard assistant 120 of FIG. 1.

At step 210, the method can receive, from a user interface, a query entered by a user. The query, which can be entered in natural language, inquires usage of a set of dashboards associated with a process.

In some examples, the process is a CI/CD process for microservices, and the set of dashboards are associated with a plurality of process pipelines (e.g., development, release, validation, deployment of microservices) of the CI/CD process.

At step 220, the method can obtain, in runtime, one or more text segments that are semantically related to the query.

In some examples, the operation of obtaining one or more text segments semantically related to the query includes converting the query into an input vector embedding, measuring similarities between the input vector embedding and a plurality of vector embeddings stored in a vector database, and ranking the similarities and identifying top N vector embeddings that are associated with highest similarities, wherein N is a predefined positive integer.

At step 230, the method can compose, in runtime, a prompt using a prompt template. The prompt template includes at least one placeholder for receiving the one or more text segments.

At step 240, the method can prompt, in runtime, a generative AI model using the prompt to generate a guide instructing usage of at least one dashboard in response to the query.

Then, at step 250, the method can present the guide generated by the generative AI model on the user interface.

In some examples, the method can further include creating the vector database based on a set of documents, which can be dashboard documents containing descriptions of the set of dashboards, and/or process documents containing domain knowledge of the process.

In some examples, the operation of creating the vector data includes dividing the set of documents into a plurality of text segments, converting the plurality of text segments into respective vector embeddings, and indexing the plurality of text segments and respective vector embeddings in the vector database.

In some examples, the method can fetch one or more documents (e.g., dashboard documents containing descriptions of the set of dashboards, and/or process documents containing domain knowledge of the process) using an AI agent and insert at least some of the dashboard information and/or domain knowledge into the prompt. The AI agent can be configured to iteratively invoke predefined functions based on the query entered by the user.

In some examples, the fetched process documents can also be divided into text segments, which can also be converted into respective vector embeddings and indexed in the vector database. The domain knowledge inserted into the prompt can be obtained through a similarity assessment of the vector embeddings, enabling the identification and retrieval of the most pertinent text segments that correspond to the user's query.

In some examples, the method can periodically update the vector database, including scanning the set of dashboard documents and process documents to detect whether there is an update to these documents.

In some examples, the method can further include retrieving, in runtime, a profile of the user, and inserting the profile of the user into the prompt, which enhances the relevance and personalization of the generated guide.

The method 200 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “send” can also be described as “receive” from a different perspective.

### Example Overview of Generative AI and Prompts

Generative AI models, foundation models, and large language models (LLMs) are interconnected concepts in the field of AI. Generative AI, a broad term, encompasses AI systems that generate content such as text, images, music, or code. Unlike discriminative AI models that aim to make decisions or predictions based on input data features, generative AI models focus on creating new data points. Foundation models are a subset of these generative AI models, serving as a starting point for developing more specialized models. LLMs, a specific type of generative AI, work with language and can understand and generate human-like text. In the context of generative AI, including LLMs, a prompt serves as an input or instruction that informs the AI of the desired content, context, or task. This allows users to guide the AI to produce tailored responses, explanations, or creative content based on the provided prompt.

In any of the examples herein, an LLM can take the form of an AI model that is designed to understand and generate human language. Such models typically leverage deep learning techniques such as transformer-based architectures to process language with a very large number (e.g., billions) of parameters. Examples include the Generative Pre-trained Transformer (GPT) developed by OpenAI, Bidirectional Encoder Representations from Transforms (BERT) by Google, A Robustly Optimized BERT Pretraining Approach developed by Facebook AI, Megatron-LM of NVIDIA, or the like. Pretrained models are available from a variety of sources.

In any of the examples herein, prompts can be provided, in runtime, to LLMs to generate responses. Prompts in LLMs can be input instructions that guide model behavior. Prompts can be textual cues, questions, or statements that users provide to elicit desired responses from the LLMs. Prompts can act as primers for the model's generative process. Sources of prompts can include user-generated queries, predefined templates, or system-generated suggestions. Technically, prompts are tokenized and embedded into the model's input sequence, serving as conditioning signals for subsequent text generation. Experiment with prompt variations can be performed to manipulate output, using techniques like prefixing, temperature control, top-K sampling, chain-of-thought, etc. These prompts, sourced from diverse inputs and tailored strategies, enable users to influence LLM-generated content by shaping the underlying context and guiding the neural network's language generation. For example, prompts can include instructions and/or examples to encourage the LLMs to provide results in a desired style and/or format.

### Example Architecture of LLM

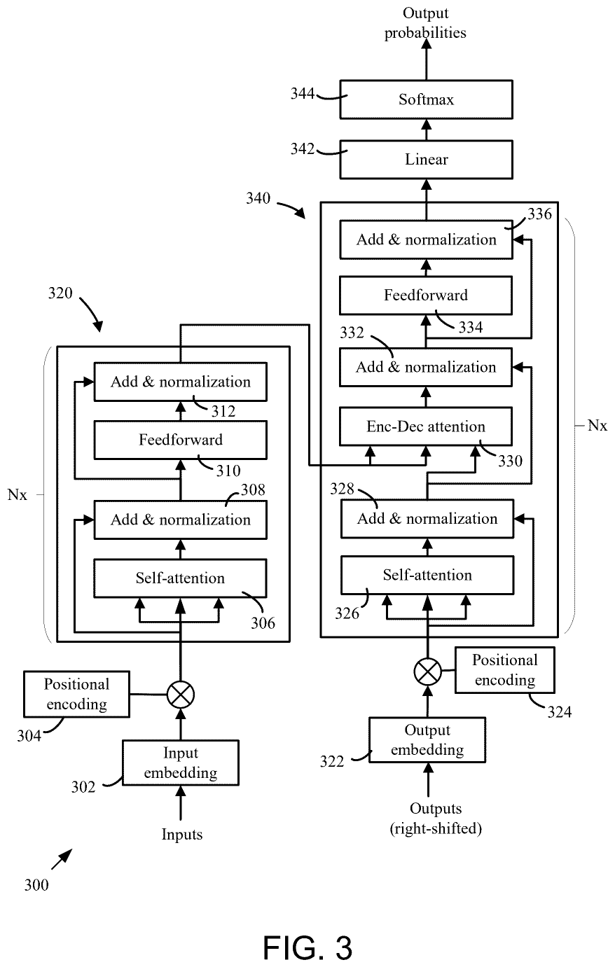

FIG. 3 shows an example architecture of an LLM 300, which can be used as the generative AI model 114 of FIG. 1.

In the depicted example, the LLM 300 uses an autoregressive model (as implemented in OpenAI's GPT) to generate text content by predicting the next word in a sequence given the previous words. The LLM 300 can be trained to maximize the likelihood of each word in the training dataset, given its context.

As shown in FIG. 3, the LLM 300 can have an encoder 320 and a decoder 340, the combination of which can be referred to as a “transformer.” The encoder 320 processes input text, transforming it into a context-rich representation. The decoder 340 takes this representation and generates text output.

For autoregressive text generation, the LLM 300 generates text in order, and for each word it generates, it relies on the preceding words for context. During training, the target or output sequence, which the model is learning to generate, is presented to the decoder 340. However, the output is right shifted by one position compared to what the decoder 340 has generated so far. In other words, the model sees the context of the previous words and is tasked with predicting the next word. As a result, the LLM 300 can learn to generate text in a left-to-right manner, which is how language is typically constructed.

Text inputs to the encoder 320 can be preprocessed through an input embedding unit 302. Specifically, the input embedding unit 302 can tokenize a text input into a sequence of tokens, each of which represents a word or part of a word. Each token can then be mapped to a fixed-length vector known as an input embedding, which provides a continuous representation that captures the meaning and context of the text input. Likewise, to train the LLM 300, the targets or output sequences presented to the decoder 340 can be preprocessed through an output embedding unit 322. Like the input embedding unit 302, the output embedding unit 322 can provide a continuous representation, or output embedding, for each token in the output sequences.

Generally, the vocabulary in LLM 300 is fixed and is derived from the training data. The vocabulary in LLM 300 consists of tokens generated above during the training process. Words not in the vocabulary cannot be output. These tokens are strung together to form sentences in the text output.

In some examples, positional encodings (e.g., 304 and 324) can be performed to provide sequential order information of tokens generated by the input embedding unit 302 and output embedding unit 322, respectively. Positional encoding is needed because the transformer, unlike recurrent neural networks, process all tokens in parallel and do not inherently capture the order of tokens. Without positional encoding, the model would treat a sentence as a collection of words, losing the context provided by the order of words. Positional encoding can be performed by mapping each position/index in a sequence to a unique vector, which is then added to the corresponding vector of input embedding or output embedding. By adding positional encoding to the input embedding, the model can understand the relative positions of words in a sentence. Similarly, by adding positional encoding to the output encoding, the model can maintain the order of words when generating text output.

Each of the encoder 320 and decoder 340 can include multiple stacked or repeated layers (denoted by Nx in FIG. 3). The number of stacked layers in the encoder 320 and/or decoder 340 can vary depending on the specific LLM architecture. Generally, a higher “N” typically means a deeper model, which can capture more complex patterns and dependencies in the data but may require more computational resources for training and inference. In some examples, the number of stacked layers in the encoder 320 can be the same as the number of stacked layers in the decoder 340. In other examples, the LLM 300 can be configured so that the encoder 320 and decoder 340 can have different numbers of layers. For example, a deeper encoder (more layers) can be used to better capture the input text's complexities while a shallower decoder (fewer layers) can be used if the output generation task is less complex).

The encoder 320 and the decoder 340 are related through shared embeddings and attention mechanisms, which allow the decoder 340 to access the contextual information generated by the encoder 320, enabling the LLM 300 to generate coherent and contextually accurate responses. In other words, the output of the encoder 320 can serve as a foundation upon which the decoder network can build the generated text.

Both the encoder 320 and decoder 340 comprise multiple layers of attention and feedforward neural networks. An attention neural network can implement an “attention” mechanism by calculating the relevance or importance of different words or tokens within an input sequence to a given word or token in an output sequence, enabling the model to focus on contextually relevant information while generating text. In other words, the attention neural network plays “attention” on certain parts of a sentence that are most relevant to the task of generating text output. A feedforward neural network can process and transform the information captured by the attention mechanism, applying non-linear transformations to the contextual embeddings of tokens, enabling the model to learn complex relationships in the data and generate more contextually accurate and expressive text.

In the example depicted in FIG. 3, the encoder 320 includes an intra-attention or self-attention neural network 306 and a feedforward neural network 310, and the decoder 340 includes a self-attention neural network 326 and a feedforward neural network 334. The self-attention neural networks 306, 326 allow the LLM 300 to weigh the importance of different words or tokens within the same input sequence (self-attention in the encoder 320) and between the input and output sequences (self-attention in the decoder 340), respectively.

In addition, the decoder 340 also includes an inter-attention or encoder-decoder attention neural network 330, which receives input from the output of the encoder 320. The encoder-decoder attention neural network 330 allows the decoder 340 to focus on relevant parts of the input sequence (output of the encoder 320) while generating the output sequence. As described below, the output of the encoder 320 is a continuous representation or embedding of the input sequence. By feeding the output of the encoder 320 to the encoder-decoder attention neural network 330, the contextual information and relationships captured in the input sequence (by the encoder 320) can be carried to the decoder 340. Such connection enables the decoder 340 to access to the entire input sequence, rather than just the last hidden state. Because the decoder 340 can attend to all words in the input sequence, the input information can be aligned with the generation of output to improve contextual accuracy of the generated text output.

In some examples, one or more of the attention neural networks (e.g., 306, 326, 330) can be configured to implement a single head attention mechanism, by which the model can capture relationships between words in an input sequence by assigning attention weights to each word based on its relevance to a target word. The term “single head” indicates that there is only one set of attention weights or one mechanism for capturing relationships between words in the input sequence. In some examples, one or more of the attention neural networks (e.g., 306, 326, 330) can be configured to implement a multi-head attention mechanism, by which multiple sets of attention weights, or “heads,” in parallel to capture different aspects of the input sequence. Each head learns distinct relationships and dependencies within the input sequence. These multiple attention heads can enhance the model's ability to attend to various features and patterns, enabling it to understand complex, multi-faceted contexts, thereby leading to more accurate and contextually relevant text generation. The outputs from multiple heads can be concatenated or linearly combined to produce a final attention output.

As depicted in FIG. 3, both the encoder 320 and the decoder 340 can include one or more addition and normalization layers (e.g., the layers 308 and 312 in the encoder 320, the layers 328, 332, and 336 in the decoder 340). The addition layer, also known as a residual connection, can add the output of another layer (e.g., an attention neural network or a feedforward network) to its input. After the addition operation, a normalization operation can be performed by a corresponding normalization layer, which normalizes the features (e.g., making the features to have zero mean and unit variance), This can help in stabilizing the learning process and reducing training time.

A linear layer 342 at the output end of the decoder 340 can transform the output embeddings into the original input space. Specifically, the output embeddings produced by the decoder 340 are forwarded to the linear layer 342, which can transform the high-dimensional output embeddings into a space where each dimension corresponds to a word in the vocabulary of the LLM 300.

The output of the linear layer 342 can be fed to a softmax layer 344, which is configured to implement a softmax function, also known as softargmax or normalized exponential function, which is a generalization of the logistic function that compresses values into a given range. Specifically, the softmax layer 344 takes the output from the linear layer 342 (also known as logits) and transforms them into probabilities. These probabilities sum up to 1, and each probability corresponds to the likelihood of a particular word being the next word in the sequence. Typically, the word with the highest probability can be selected as the next word in the generated text output.

Still referring to FIG. 3, the general operation process for the LLM 300 to generate a reply or text output in response to a received prompt input is described below.

First, the input text is tokenized, e.g., by the input embedding unit 302, into a sequence of tokens, each representing a word or part of a word. Each token is then mapped to a fixed-length vector or input embedding. Then, positional encoding 304 is added to the input embeddings to retain information regarding the order of words in the input text.

Next, the input embeddings are processed by the self-attention neural network 306 of the encoder 320 to generate a set of hidden states. As described above, multi-head attention mechanism can be used to focus on different parts of the input sequence. The output from the self-attention neural network 306 is added to its input (residual connection) and then normalized at the addition and normalization layer 308.

Then, the feedforward neural network 310 is applied to each token independently. The feedforward neural network 310 includes fully connected layers with non-linear activation functions, allowing the model to capture complex interactions between tokens. The output from the feedforward neural network 310 is added its input (residual connection) and then normalized at the addition and normalization layer 312.

The decoder 340 uses the hidden states from the encoder 320 and its own previous output sequence to generate the next token in an autoregressive manner so that the sequential output is generated by attending to the previously generated tokens. Specifically, the output of the encoder 320 (input embeddings processed by the encoder 320) are fed to the encoder-decoder attention neural network 330 of the decoder 340, which allows the decoder 340 to attend to all words in the input sequence. As described above, the encoder-decoder attention neural network 330 can implement a multi-head attention mechanism, e.g., computing a weighted sum of all the encoded input vectors, with the most relevant vectors being attributed the highest weights.

The previous output sequence of the decoder 340 is first tokenized by the output embedding unit 322 to generate an output embedding for each token in the output sequence. Similarly, positional embedding 324 is added to the output embedding to retain information regarding the order of words in the output sequence.

The output embeddings are processed by the self-attention neural network 326 of the decoder 340 to generate a set of hidden states. The self-attention mechanism allows each token in the text output to attend to all tokens in the input sequence as well as all previous tokens in the output sequence. The output from the self-attention neural network 326 is added to its input (residual connection) and then normalized at the addition and normalization layer 328.

The encoder-decoder attention neural network 330 receives the output embeddings processed through the self-attention neural network 326 and the addition and normalization layer 328. Additionally, the encoder-decoder attention neural network 330 also receives the output from the addition and normalization layer 312 which represents input embeddings processed by the encoder 320. By considering both processed input embeddings and output embeddings, the output of the encoder-decoder attention neural network 330 represents an output embedding which takes into account both the input sequence and the previously generated outputs. As a result, the decoder 340 can generate the output sequence that is contextually aligned with the input sequence.

The output from the encoder-decoder attention neural network 330 is added to part of its input (residual connection), i.e., the output from the addition and normalization layer 328, and then normalized at the addition and normalization layer 332. The normalized output from the addition and normalization layer 332 is then passed through the feedforward neural network 334. The output of the feedforward neural network 334 is then added to its input (residual connection) and then normalized at the addition and normalization layer 336.

The processed output embeddings output by the decoder 340 are passed through the linear layer 342, which maps the high-dimensional output embeddings back to the size of the vocabulary, that is, it transforms the output embeddings into a space where each dimension corresponds to a word in the vocabulary. The softmax layer 344 then converts output of the linear layer 342 into probabilities, each of which corresponds to the likelihood of a particular word being the next word in the sequence. Finally, the LLM 300 samples an output token from the probability distribution generated by the softmax layer 344 (e.g., selecting the token with the highest probability), and this token is added to the sequence of generated tokens for the text output.

The steps described above are repeated for each new token until an end-of-sequence token is generated or a maximum length is reached. Additionally, if the encoder 320 and/or decoder 340 have multiple stacked layers, the steps performed by the encoder 320 and decoder 340 are repeated across each layer in the encoder 320 and the decoder 340 for generation of each new token.

### Example Dashboards

Dashboards in an ERP environment serve as interactive data visualization tools that consolidate information across various processes into a single interface, facilitating informed decision-making. Typically, a dashboard's layout can be composed of multiple panels or tiles, each housing distinct data objects that convey key performance indicators (KPIs) and metrics. These data objects can take the form of various types of charts—such as bar, line, and pie charts—graphs, tables, and gauges, each designed to present data in a visually intuitive manner. As an example, FIG. 4 depicts a portion of the layout of an example dashboard for Microdelivery Overview, which provides a summary of ongoing deliveries of microservices in the CI/CD microdelivery process.

A process supported by the ERP system is often associated with a set of related dashboards, each focusing on different aspects of the process. For example, in the CI/CD microdelivery process, additional dashboards can complement the Microdelivery Overview by providing deeper insights. Specifically, a Microservice Overview dashboard can detail the health and performance of individual microservices; a Pipeline Stability & Runtime dashboard can offers insights into pipeline stability metrics, runtimes, and stages; a Completed Pipeline & Stages dashboard can highlight executed pipeline counts, associated costs, and underlying technologies; an E2E Delivery Time dashboard can tracks end-to-end delivery times; a DORA KPIs dashboard can evaluates various KPIs; and an Adoption dashboard can monitor user engagement with the services (e.g., utilization metrics). Together, these dashboards can provide a comprehensive view of the CI/CD microdelivery process, with information that may overlap or complement each other.

The composition of a dashboard can be customized based on the needs of its users. Customization options may include rearranging the layout of panels, selecting specific data visualizations, and adding or removing data objects to focus on the most relevant information. Users can personalize their dashboards by choosing which KPIs to display, allowing them to track metrics that align with their individual responsibilities or goals. Additionally, dashboards often feature filters that enable users to refine the data presented. These filters can be applied based on various criteria, such as time periods, categories, or geographic locations, allowing users to drill down into specific subsets of data for more detailed analysis.

Given the complexity and volume of information across interconnected dashboards, effectively navigating and interpreting these data points can be challenging-especially for users who may be unfamiliar with the nuances of the associated process. For example, a user may struggle to identify which charts and analytics are available within a set of dashboards. The technologies disclosed herein address this complexity by providing an intelligent dashboard guide that directs users to relevant dashboards tailored to their specific needs, explains the purpose of each component and how to use them in combination, and offers step-by-step guidance on applying filters and customizations across both dashboards and individual charts.

### Example Dashboard Documents

To enable rapid retrieval of dashboard information and provide contextually relevant guidance to users, a vector store (e.g., 138) can be created (e.g., in the design phase) with vector embeddings derived from dashboard and process documentation. The vector store allows the intelligent dashboard assistant (e.g., 120) to efficiently match user queries with relevant dashboard content, as detailed above.

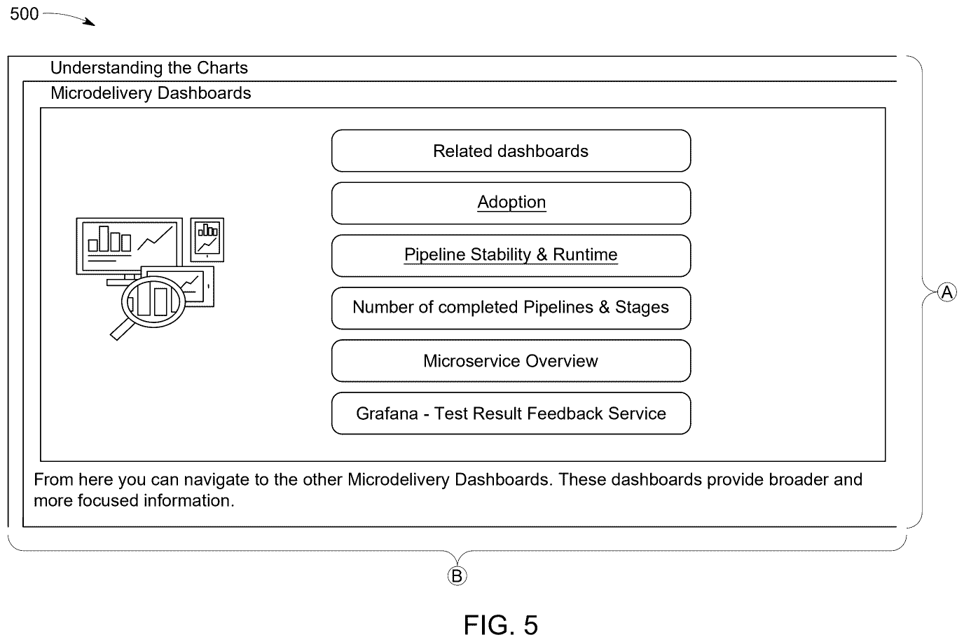

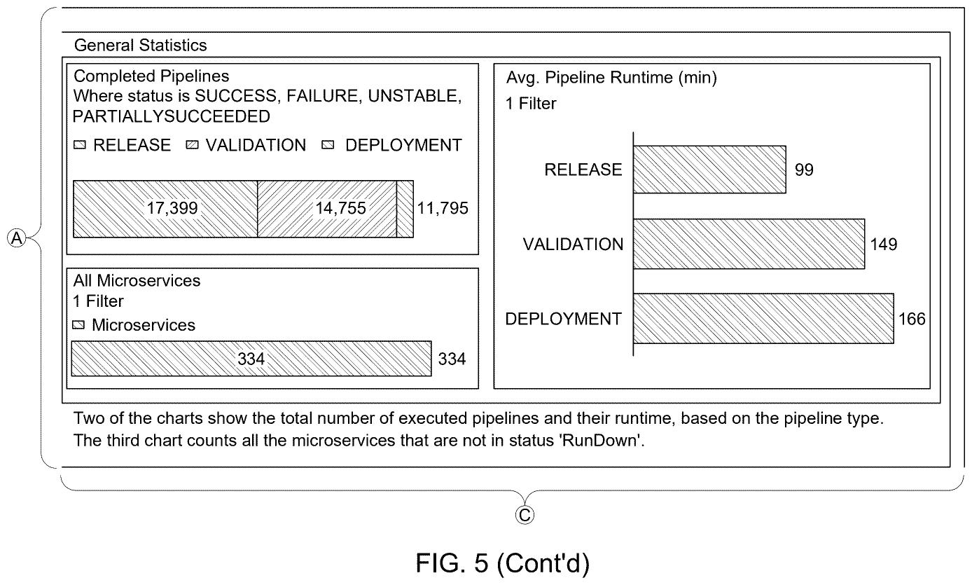

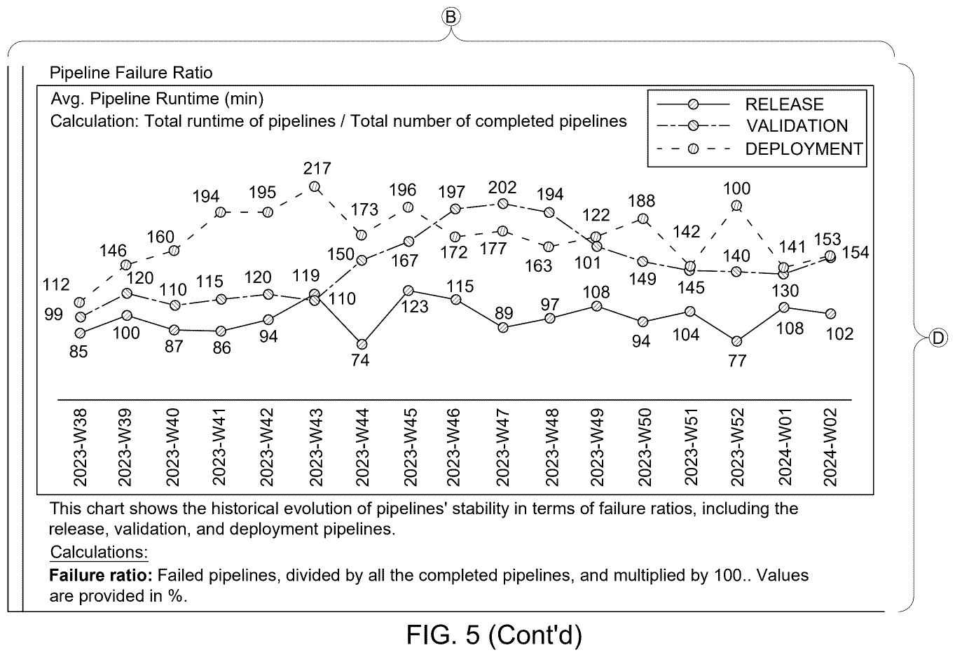

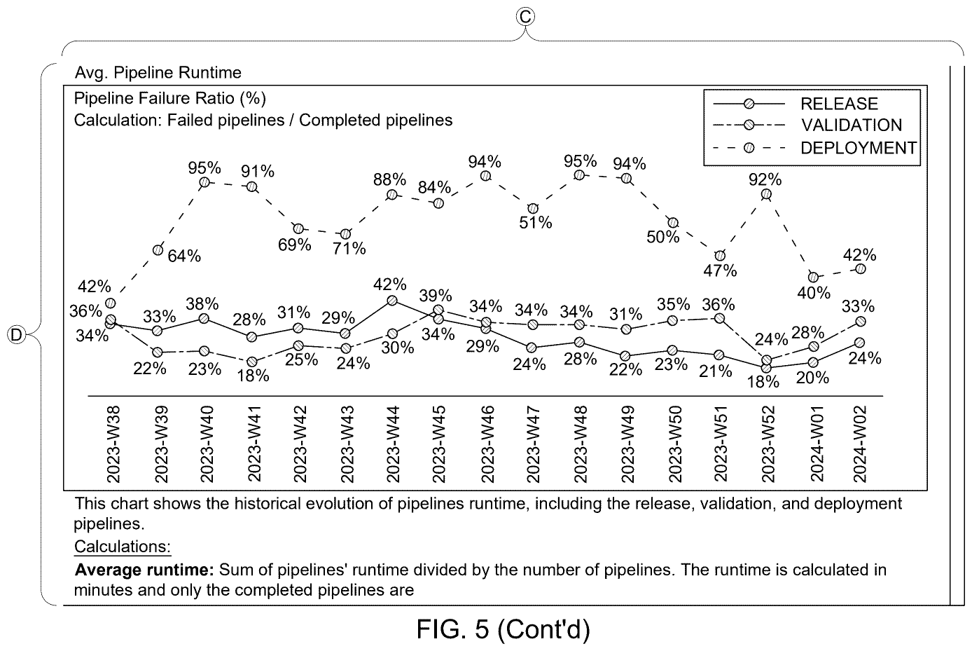

As an example, FIG. 5 illustrates a snippet of an example dashboard document on the microdelivery process, which includes a summary of available microdelivery dashboards, descriptions of available statistics, charts and analytics, and explanations on how to calculate and interpret those statistics, charts, and analytics, among other relevant information.

As described above, the creation of the vector store begins with a data injection pipeline (e.g. 136) that aggregates available dashboard documents. An indexing pipeline (e.g., 132) can process these documents by segmenting them into smaller, contextually coherent segments. Each segment can be transformed by an embedding engine (e.g., 122) into a vector embedding that captures its semantic meaning, and the generated vector embedding can be indexed within the vector store.

### Example Domain Knowledge

To accurately interpret and utilize dashboards for a specific process, it is important to understand the underlying domain knowledge underlying these dashboards. This domain-specific knowledge, which can be documented in the form of process guides, knowledge transfers, and how-to descriptions, provides the context for interpreting the charts, filters, and analytics available within the dashboards. During the design phase, such domain knowledge can be retrieved from related process documents and segmented into contextually relevant pieces, which are then converted into vector embeddings and stored in the vector store (e.g., 138), as described above. Properly indexed, this domain knowledge enables the intelligent dashboard assistant to offer a more accurate and informative guide to navigating dashboards, helping users understand the relevance and application of each analytic element within the context of the broader process.

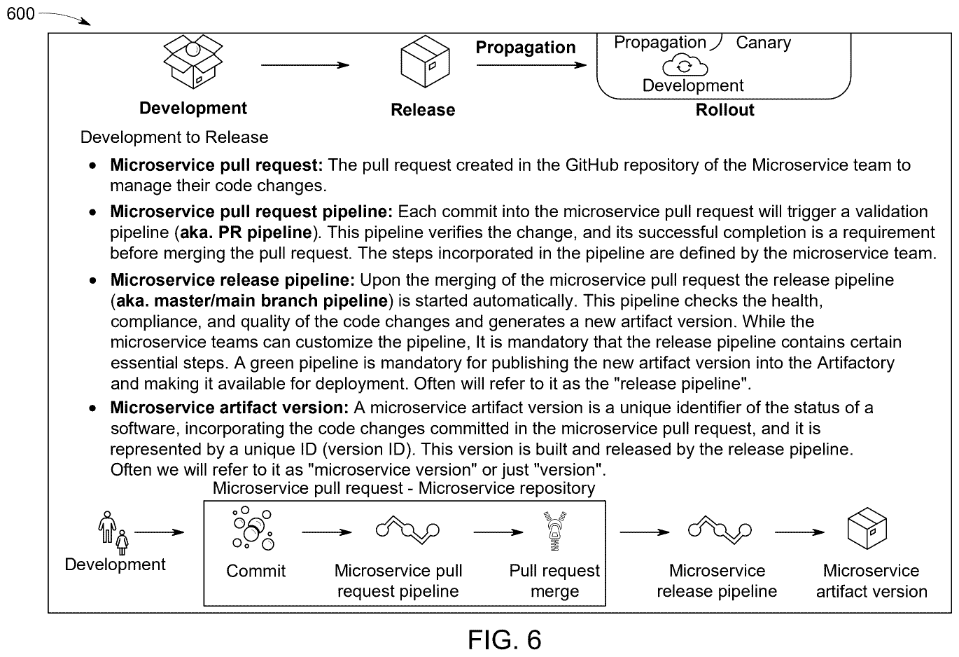

As an example, FIG. 6 shows an excerpt of a process document which describes different pipelines of the microdelivery process and terminology associated with various microdelivery pipelines, among other relevant contextual information.

### Example AI Agents

In some examples, the AI agent 124 of FIG. 1 can be configured to iteratively gather and retrieve context information from the database 130, including text segments containing dashboard information and domain knowledge, and user profile 105 that are associated with the user query 102. For example, the retrieved dashboard information may indicate what dashboards are most relevant to the user query, what statistics, charts and analytics are available on those dashboards, and how to configure (e.g., filters) those dashboards. The retrieved domain knowledge may indicate how multiple microdelivery pipeline are differentiated (e.g., development, release, validation, deployment), and how they relate to each other in the microdelivery process. In some examples, the AI agent 124 can be implemented using the ReAct framework, which allows an LLM (e.g., the generative AI model 114) to engage in a structured sequence of “thought-action-observation” steps to retrieve and contextualize information effectively.

In some examples, the ReAct framework can help the AI agent define actions based on the user's query, systematically retrieving definitions for any unfamiliar concepts as needed. For instance, the AI agent can use the following prompt to iteratively prompt the generative AI model to retrieve relevant context information including domain knowledge:

| | |
|---|---|
| | You are given some documentation and are asked to find information for all the |
| | concepts that you do not know or may have context-specific definitions. Use the |
| | following format: |
| 1. | Question: the input question from the user |
| 2. | Thought: you should always think about what to do |
| 3. | Action: define the action which is to be executed next, should be one of the [{tools}] |
| 4. | Action input: the input parameter, context, information to the action defined in step 3 |
| 5. | Observation: the result of the action ... |
| | (this Thought/Action/Action Input/Observation can repeat N times) |
| 6. | Thought: I now know the final answer |
| 7. | Final answer: the final answer to the original input question |
| | Begin! |
| | Question: { question} |

In this example, the placeholder {tools} represents the set of functions available to the AI agent for processing the user query and retrieving relevant context information. These tools may include operations to convert the query into a vector, perform the documentation embedding, fetch the top N most relevant text segments, and retrieve the user profile. The {question} placeholder corresponds to the specific query posed by the user.

### Example Runtime Generation of Intelligent Dashboard Guide

After creating the database 130 (including the vector store 138) based on dashboard and process documents, the intelligent dashboard assistant 120 can dynamically generate a personalized dashboard guide at runtime. As described above, the guide creation process involves constructing a prompt using a prompt template and sending the prompt to the generative AI model (e.g., 114) for processing.

The prompt template can include a plurality of placeholders which are populated with relevant context information retrieved by the AI agent 124. For example, one placeholder can be filled with text segments containing relevant domain knowledge of the process, and another placeholder can be filled with text segments including descriptions of relevant dashboard documents. As described above, these text segments can be determined based on similarity analysis of the AI agent 124, which performs a semantic search across the vector store to retrieve the text segments that most closely align with the user query.

In some examples, the user's profile information, such as the user's role, product responsibility, and experience level, can be retrieved automatically based on the user identifier from the user query. A placeholder in the prompt template can be populated with the retrieved user profile. The prompt template can be configured to instruct the generative AI model to tailor the guide based on the user's specific needs and responsibilities.

An example prompt template is listed below:

You are a helpful assistant that helps users to navigate a set of dashboards to perform a
given analysis. The user may be overwhelmed by the amount of data and visualizations
available to them, and it is therefore your task to boil it down into an easy, step-by-step
guide of what to do.
If you have no concrete recommendation, for instance because the user query is
irrelevant, you should respond “No recommendation”. Only return relevant
information.
As an example, a generated guide may look like this:

| | Dear Ms./Mr. <name> |
|---|---|
| 1. | Step 1: look at figure 3 in dashboard A. Here you can analyze <...> |
| 2. | Step 2: Now look at figure 2 in dashboard B. This will help you to understand <...> |
| 3. | Step 3: Finally, scroll down to figure 4 in dashboard B, which will help you |

understand <...>
Here is some domain knowledge you might need: {domain_knowledge}
Here are descriptions of the graphs that may be relevant: {dashboard_documentation}
These filters are available for each of the dashboards: {dashboard_filters}
This is the user information: {user_information}
Use this format:
Question: question here
personalised_guide: the guide
This is the user question: {question}

In this example, the prompt template specifies the role and task of the generative AI model, instructions to create a step-by-step guide for navigating a relevant dashboard (with an example), and a plurality of placeholders which can be populated with relevant context information for the generative AI model. In the depicted example, the placeholders include {domain_knowledge} which can be populated with domain knowledge of the process (e.g., retrieved from the process document), {dashboard_documentation} which can be populated with descriptions of charts available in the dashboards (e.g., extracted from the dashboard documents), {dashboard_filters} which can be populated with descriptions of filters and their configuration options (e.g., extracted from the dashboard documents), {user_information} which can be populated with automatically retrieved user profiles, and {question} which represents the user query.

After receiving the prompt, the generative AI model can generate a response containing a personalized guide for the user. In some examples, the response produced by the generative AI can be further formatted into a desired format for presentation on the user interface. For instance, the generative AI model can be automatically prompted again using a follow-up prompt to reformat the response as structured HTML:

Given this user guide, please return the guide as a HTML-formatted text, when needed
use indentation and paragraphs, and show all chart names in bold.
{ personalised_guide }

### Example Use Case

An example use case is described herein to further illustrate the intelligent dashboard assistant technologies described herein.

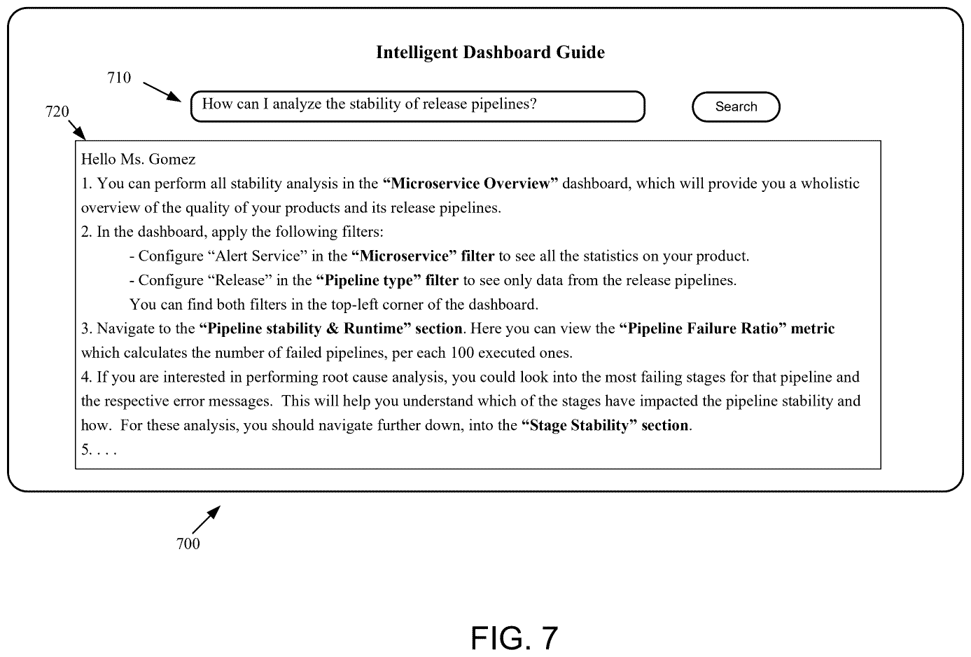

FIG. 7 shows an example user interface 700 (which can be an example embodiment of the user interface 104) to an intelligent dashboard assistant. A user can enter a query 710 in a text box, asking “How can I analyze the stability of release pipelines?” After receiving the user query 710, the intelligent dashboard assistant can search the vector store to identify the following domain knowledge retrieved from a process document that is deemed to be semantically aligned with the user query 710:

The Microdelivery process has four different types of pipelines: ‘microservice pull
request pipeline’, ‘release pipeline’, ‘validation pipeline’, and ‘deployment pipeline’.
Each of which has a specific purpose in the end-to-end delivery process.
The first two pipeline types are relevant only for product changes, they are not used for
configuration or stencil changes.
The release pipeline is started automatically upon the merging of the microservice pull
request the release pipeline. This pipeline checks the health, compliance, and quality of
the code changes and generates a new artifact version. While the microservice teams
can customize the pipeline, it is mandatory that the release pipeline contains certain
essential steps. A green pipeline is mandatory for publishing the new artifact version
into the Artifactory and making it available for propagation and deployment.
. . .

By searching the vector store, the intelligent dashboard assistant can also identify the following text excerpts from dashboard documents containing descriptions of a dashboard which semantically match the user's inquiry (e.g., “stability of release pipelines”):

Stage Stability
Here you can analyze stages' stability and understand their impact on pipeline quality.
This section is split in three parts, each dedicated to one pipeline type: release,
validation, and deployment.
Every pipeline type has its unique list of stages, it is not to be expected that the same
stages are listed and have data for all pipelines.
In the upper chart you see a listing of the stages with the highest failure ratio, the
specified time period. From this chart you can identify those stages with the highest
percentage of failures. Selecting a stage in the ‘Stages With the Highest Failure Rate’
chart automatically updates the ‘Stage Failure Ratio’ and “Stage Failure Messages,
Normalized and Grouped” charts to reflect the historical trend of the selected stage's
failure rate.
In the lower chart you can analyze the historical trend for a specific stage. You can
select in the list of stages, positioned in the left side, the stage for which you want to see
the historical trend and failure messages.
On the bottom you see a list of the failure messages generated during the execution of
pipeline stages, offering insights into common errors and abnormalities. This
information is crucial for pinpointing and addressing the root causes of stage failures.
Failure message normalization and grouping:
Failure messages are processed to better identify common patterns among them. Using
regex, tokenization, and text simplification strategies, we have cleaned up the messages
by removing execution-specific information and identifying the error types. Once the
messages are processed and normalized, they are grouped with similar ones, organized
by stage.
. . .

Additionally, from the identified dashboard documents, the intelligent dashboard assistant can retrieve the following filter information:

Microservice: Specify the microservice for which you want to see statistical analyzes.
Time frame (weeks): You can limit all statistics in the charts to a defined time period.
The time period is defined by an interval, where you specify its first and last week.
Pipeline type: The type of pipelines(release, validation, deployment, etc.) can be chosen
using this filter. The list of selected pipeline types will impact the data shown in the
charts of this dashboard.
. . .

Further, the intelligent dashboard assistant can automatically retrieve the following profile information of the user:

Name: Gomez
Role: Product owner
Working on product: “Alert Service”
. . .

By populating the above context information into the prompt template described above, the intelligent dashboard assistant can create a customized guide for the user, presented as an output 720 on the user interface 700, formatted as a detailed, step-by-step instructional sequence.

### Example Advantages

The technologies described herein offer several technical advantages that enhance user experience, efficiency, and accuracy when navigating and interpreting complex ERP dashboards.

First, the disclosed technologies enable the intelligent generation of a cohesive dashboard guide that harmonizes insights across fragmented layouts and design patterns, providing users with a consistent interpretation layer. The intelligent dashboard assistant disclosed herein can retrieve and synthesize data from multiple dashboards, normalizing diverse chart formats, filters, and terminologies into a consolidated interface that maintains consistency in data presentation. This automated dashboard guide simplifies the complex dashboard landscape, especially for users unfamiliar with navigating different interfaces, by directing them through essential metrics that might otherwise be overlooked due to varying dashboard designs.

Second, by dynamically analyzing user queries and leveraging contextual metadata-such as domain—specific knowledge—the intelligent dashboard assistant disclosed herein can provide context-aware recommendations that enhance data interpretation. In scenarios involving complex workflows, like the microservice delivery process, the intelligent dashboard assistant applies similarity-based retrieval to extract relevant process information, which can be used by the generative AI Model to produce an informed guide which allows the user to see metrics/analytics in relation to specific pipeline stages or requirements within their workflow.

Further, by leveraging generative AI, the intelligent dashboard assistant disclosed herein can dynamically generate personalized guides that adapt to individual user roles, specific data requirements, and relevant workflows. This role-specific customization can reduce time spent on manually configuring filters and settings, enabling users to quickly access pertinent insights without sifting through irrelevant data.

### Example Computing Systems

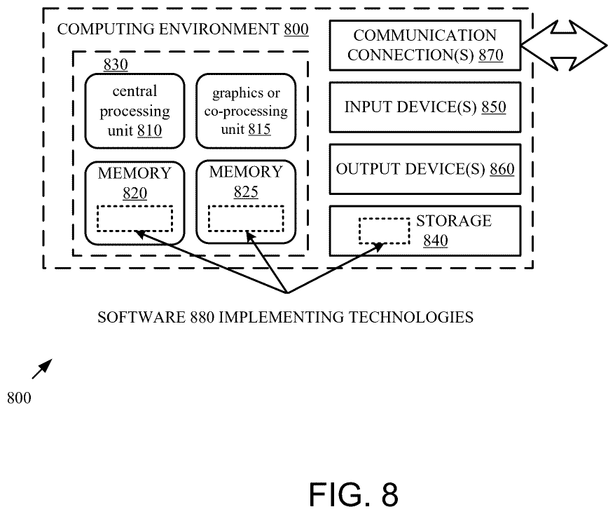

FIG. 8 depicts an example of a suitable computing system 800 in which the described innovations can be implemented. The computing system 800 is not intended to suggest any limitation as to scope of use or functionality of the present disclosure, as the innovations can be implemented in diverse computing systems.

With reference to FIG. 8, the computing system 800 includes one or more processing units 810, 815 and memory 820, 825. In FIG. 8, this basic configuration 830 is included within a dashed line. The processing units 810, 815 can execute computer-executable instructions, such as for implementing the features described in the examples herein (e.g., the method 200). A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 8 shows a central processing unit 810 as well as a graphics processing unit or co-processing unit 815. The tangible memory 820, 825 can be volatile memory (e.g., registers, cache, RAM), non-volatile memory (e.g., ROM, EEPROM, flash memory, etc.), or some combination of the two, accessible by the processing unit(s) 810, 815. The memory 820, 825 can store software 880 implementing one or more innovations described herein, in the form of computer-executable instructions suitable for execution by the processing unit(s) 810, 815.

A computing system 800 can have additional features. For example, the computing system 800 can include storage 840, one or more input devices 850, one or more output devices 860, and one or more communication connections 870, including input devices, output devices, and communication connections for interacting with a user. An interconnection mechanism (not shown) such as a bus, controller, or network can interconnect the components of the computing system 800. Typically, operating system software (not shown) can provide an operating environment for other software executing in the computing system 800, and coordinate activities of the components of the computing system 800.

The tangible storage 840 can be removable or non-removable, and includes magnetic disks, magnetic tapes or cassettes, CD-ROMs, DVDs, or any other medium which can be used to store information in a non-transitory way and which can be accessed within the computing system 800. The storage 840 can store instructions for the software implementing one or more innovations described herein.

The input device(s) 850 can be an input device such as a keyboard, mouse, pen, or trackball, a voice input device, a scanning device, touch device (e.g., touchpad, display, or the like) or another device that provides input to the computing system 800. The output device(s) 860 can be a display, printer, speaker, CD-writer, or another device that provides output from the computing system 800.

The communication connection(s) 870 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example Cloud Computing Environment

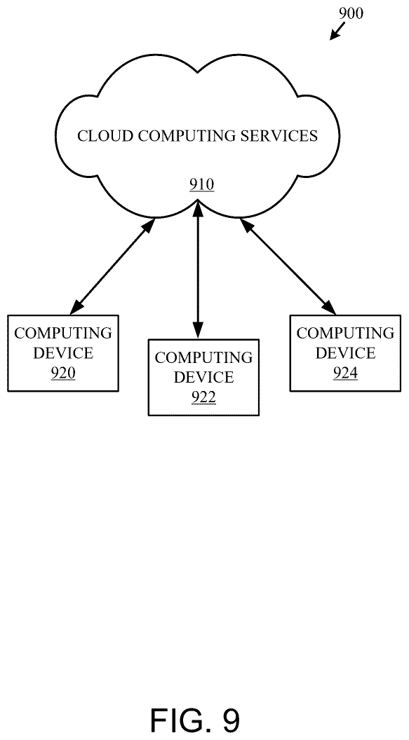

FIG. 9 depicts an example cloud computing environment 900 in which the described technologies can be implemented, including, e.g., the system 100 and other systems herein. The cloud computing environment 900 can include cloud computing services 910. The cloud computing services 910 can comprise various types of cloud computing resources, such as computer servers, data storage repositories, networking resources, etc. The cloud computing services 910 can be centrally located (e.g., provided by a data center of a business or organization) or distributed (e.g., provided by various computing resources located at different locations, such as different data centers and/or located in different cities or countries).

The cloud computing services 910 can be utilized by various types of computing devices (e.g., client computing devices), such as computing devices 920, 922, and 924. For example, the computing devices (e.g., 920, 922, and 924) can be computers (e.g., desktop or laptop computers), mobile devices (e.g., tablet computers or smart phones), or other types of computing devices. For example, the computing devices (e.g., 920, 922, and 924) can utilize the cloud computing services 910 to perform computing operations (e.g., data processing, data storage, and the like).

In practice, cloud-based, on-premises-based, or hybrid scenarios can be supported.

### Example Implementations

In any of the examples herein, a software application (or “application”) can take the form of a single application or a suite of a plurality of applications, whether offered as a service (SaaS), in the cloud, on premises, on a desktop, mobile device, wearable, or the like.

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

Although specific prompt templates are described above, it should be understood that these prompt templates are merely examples for illustration purposes, and different prompt templates can be used based on the principles described herein.

In any of the examples described herein, an operation performed in runtime or real-time means that the operation can be completed with negligible processing latency (e.g., the operation can be completed within 1 second, etc.).

### Example Clauses

Any of the following example clauses can be implemented.

Clause 1. A computing system comprising: memory; one or more hardware processors coupled to the memory; and one or more computer readable storage media storing instructions that, when loaded into the memory, cause the one or more hardware processors to perform operations comprising: receiving, from a user interface, a query entered by a user, wherein the query inquires usage of a set of dashboards associated with a process; obtaining, in runtime, one or more text segments that are semantically related to the query; composing, in runtime, a prompt using a prompt template, wherein the prompt template includes at least one placeholder for receiving the one or more text segments; prompting, in runtime, a generative artificial intelligence (AI) model using the prompt to generate a guide instructing usage of at least one dashboard in response to the query; and presenting the guide generated by the generative AI model on the user interface.

Clause 2. The computing system of clause 1, wherein the operation of obtaining one or more text segments semantically related to the query comprises converting the query into an input vector embedding.

Clause 3. The computing system of clause 2, wherein the operation of obtaining one or more text segments semantically related to the query further comprises measuring similarities between the input vector embedding and a plurality of vector embeddings stored in a vector database.

Clause 4. The computing system of clause 3, wherein the operation of obtaining one or more text segments semantically related to the query further comprises ranking the similarities and identifying top N vector embeddings that are associated with highest similarities, wherein N is a predefined positive integer.

Clause 5. The computing system of any one of clauses 3-4, wherein the operations further comprise creating the vector database based on a set of dashboard documents containing descriptions of the set of dashboards.

Clause 6. The computing system of clause 5, wherein the operation of creating the vector database comprises dividing the set of dashboard documents into a plurality of text segments.

Clause 7. The computing system of clause 6, wherein the operation of creating the vector database further comprises converting the plurality of text segments into respective vector embeddings, and indexing the plurality of text segments and respective vector embeddings in the vector database.

Clause 8. The computing system of any one of clauses 1-7, wherein the operations further comprise fetching one or more process documents containing domain knowledge of the process using an AI agent, and inserting at least some of the domain knowledge into the prompt, wherein the AI agent is configured to iteratively invoke predefined functions based on the query entered by the user.

Clause 9. The computing system of any one of clauses 1-8, wherein the operations further comprise retrieving, in runtime, a profile of the user, and inserting the profile of the user into the prompt.

Clause 10. The computing system of any one of clauses 1-9, wherein the process is a continuous integration and continuous delivery (CI/CD) process for microservices, wherein the set of dashboards are associated with a plurality of sequential stages of the CI/CD process.

Clause 11. A computer-implemented method comprising: receiving, from a user interface, a query entered by a user, wherein the query inquires usage of a set of dashboards associated with a process; obtaining, in runtime, one or more text segments that are semantically related to the query; composing, in runtime, a prompt using a prompt template, wherein the prompt template includes at least one placeholder for receiving the one or more text segments; prompting, in runtime, a generative artificial intelligence (AI) model using the prompt to generate a guide instructing usage of at least one dashboard in response to the query; and presenting the guide generated by the generative AI model on the user interface.

Clause 12. The computer-implemented method of clause 11, wherein obtaining one or more text segments semantically related to the query comprises converting the query into an input vector embedding.

Clause 13. The computer-implemented method of clause 12, wherein obtaining one or more text segments semantically related to the query further comprises measuring similarities between the input vector embedding and a plurality of vector embeddings stored in a vector database.

Clause 14. The computer-implemented method of clause 13, wherein obtaining one or more text segments semantically related to the query further comprises ranking the similarities and identifying top N vector embeddings that are associated with highest similarities, wherein N is a predefined positive integer.

Clause 15. The computer-implemented method of any one of clauses 13-14, further comprising creating the vector database based on a set of dashboard documents containing descriptions of the set of dashboards.

Clause 16. The computer-implemented method of clause 15, wherein creating the vector database comprises dividing the set of dashboard documents into a plurality of text segments.

Clause 17. The computer-implemented method of clause 16, wherein creating the vector database further comprises converting the plurality of text segments into respective vector embeddings, and indexing the plurality of text segments and respective vector embeddings in the vector database.

Clause 18. The computer-implemented method of any one of clauses 11-17, further comprising fetching one or more process documents containing domain knowledge of the process using an AI agent, and inserting at least some of the domain knowledge into the prompt, wherein the AI agent is configured to iteratively invoke predefined functions based on the query entered by the user.

Clause 19. The computer-implemented method of any one of clauses 11-18, further comprising retrieving, in runtime, a profile of the user, and inserting the profile of the user into the prompt.

Clause 20. One or more non-transitory computer-readable media having encoded thereon computer-executable instructions causing one or more processors to perform a method, the method comprising: receiving, from a user interface, a query entered by a user, wherein the query inquires usage of a set of dashboards associated with a process; obtaining, in runtime, one or more text segments that are semantically related to the query; composing, in runtime, a prompt using a prompt template, wherein the prompt template includes at least one placeholder for receiving the one or more text segments; prompting, in runtime, a generative artificial intelligence (AI) model using the prompt to generate a guide instructing usage of at least one dashboard in response to the query; and presenting the guide generated by the generative AI model on the user interface.

The technologies from any clause can be combined with the technologies described in any one or more of the other clauses.

In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
memory;
one or more hardware processors coupled to the memory; and
one or more computer readable storage media storing instructions that, when loaded into the memory, cause the one or more hardware processors to perform operations comprising:
receiving, from a user interface, a query entered by a user, wherein the query inquires usage of a set of dashboards associated with a process;
obtaining, in runtime, one or more text segments that are semantically related to the query;
composing, in runtime, a prompt using a prompt template, wherein the prompt template includes at least one placeholder for receiving the one or more text segments;
prompting, in runtime, a generative artificial intelligence (AI) model using the prompt to generate a guide instructing usage of at least one dashboard in response to the query; and
presenting the guide generated by the generative AI model on the user interface.

2. The computing system of claim 1, wherein the operation of obtaining one or more text segments semantically related to the query comprises converting the query into an input vector embedding.

3. The computing system of claim 2, wherein the operation of obtaining one or more text segments semantically related to the query further comprises measuring similarities between the input vector embedding and a plurality of vector embeddings stored in a vector database.

4. The computing system of claim 3, wherein the operation of obtaining one or more text segments semantically related to the query further comprises ranking the similarities and identifying top N vector embeddings that are associated with highest similarities, wherein N is a predefined positive integer.

5. The computing system of claim 3, wherein the operations further comprise creating the vector database based on a set of dashboard documents containing descriptions of the set of dashboards.

6. The computing system of claim 5, wherein the operation of creating the vector database comprises dividing the set of dashboard documents into a plurality of text segments.

7. The computing system of claim 6, wherein the operation of creating the vector database further comprises converting the plurality of text segments into respective vector embeddings, and indexing the plurality of text segments and respective vector embeddings in the vector database.

8. The computing system of claim 1, wherein the operations further comprise fetching one or more process documents containing domain knowledge of the process using an AI agent, and inserting at least some of the domain knowledge into the prompt, wherein the AI agent is configured to iteratively invoke predefined functions based on the query entered by the user.

9. The computing system of claim 1, wherein the operations further comprise retrieving, in runtime, a profile of the user, and inserting the profile of the user into the prompt.

10. The computing system of claim 1, wherein the process is a continuous integration and continuous delivery (CI/CD) process for microservices, wherein the set of dashboards are associated with a plurality of sequential stages of the CI/CD process.

11. A computer-implemented method comprising:
receiving, from a user interface, a query entered by a user, wherein the query inquires usage of a set of dashboards associated with a process;
obtaining, in runtime, one or more text segments that are semantically related to the query;
composing, in runtime, a prompt using a prompt template, wherein the prompt template includes at least one placeholder for receiving the one or more text segments;
prompting, in runtime, a generative artificial intelligence (AI) model using the prompt to generate a guide instructing usage of at least one dashboard in response to the query; and
presenting the guide generated by the generative AI model on the user interface.

12. The computer-implemented method of claim 11, wherein obtaining one or more text segments semantically related to the query comprises converting the query into an input vector embedding.

13. The computer-implemented method of claim 12, wherein obtaining one or more text segments semantically related to the query further comprises measuring similarities between the input vector embedding and a plurality of vector embeddings stored in a vector database.

14. The computer-implemented method of claim 13, wherein obtaining one or more text segments semantically related to the query further comprises ranking the similarities and identifying top N vector embeddings that are associated with highest similarities, wherein N is a predefined positive integer.

15. The computer-implemented method of claim 13, further comprising creating the vector database based on a set of dashboard documents containing descriptions of the set of dashboards.

16. The computer-implemented method of claim 15, wherein creating the vector database comprises dividing the set of dashboard documents into a plurality of text segments.

17. The computer-implemented method of claim 16, wherein creating the vector database further comprises converting the plurality of text segments into respective vector embeddings, and indexing the plurality of text segments and respective vector embeddings in the vector database.

18. The computer-implemented method of claim 11, further comprising fetching one or more process documents containing domain knowledge of the process using an AI agent, and inserting at least some of the domain knowledge into the prompt, wherein the AI agent is configured to iteratively invoke predefined functions based on the query entered by the user.

19. The computer-implemented method of claim 11, further comprising retrieving, in runtime, a profile of the user, and inserting the profile of the user into the prompt.

20. One or more non-transitory computer-readable media having encoded thereon computer-executable instructions causing one or more processors to perform a method, the method comprising:
receiving, from a user interface, a query entered by a user, wherein the query inquires usage of a set of dashboards associated with a process;
obtaining, in runtime, one or more text segments that are semantically related to the query;
composing, in runtime, a prompt using a prompt template, wherein the prompt template includes at least one placeholder for receiving the one or more text segments;
prompting, in runtime, a generative artificial intelligence (AI) model using the prompt to generate a guide instructing usage of at least one dashboard in response to the query; and
presenting the guide generated by the generative AI model on the user interface.
